(19) United States
(12) Patent Application Publication
(10) Pub. No.: US 2014/0047124 A1
(43) Pub. Date: Feb. 13, 2014

(54) TRIVIAL FILE TRANSFER PROTOCOL (TFTP) DATA TRANSFERRING PRIOR TO FILE TRANSFER COMPLETION

(71) Applicants: Nathaniel John Simcoe, Phoenix, AZ (US); Dean E. Sunderland, Glendale, AZ (US)

(72) Inventors: Nathaniel John Simcoe, Phoenix, AZ (US); Dean E. Sunderland, Glendale, AZ (US)

(73) Assignee: HONEYWELL INTERNATIONAL INC., Morristown, NJ (US)

(21) Appl. No.: 13/572,106

(22) Filed: Aug. 10, 2012

(51) Int. Cl. G06F 15/16

(52) U.S. Cl. 709/232

(57) ABSTRACT

One embodiment is directed toward a method of transferring data using a Trivial File Transfer Protocol (TFTP). The method includes receiving a first subset of TFTP data packets containing first payload data for the file, extracting the first payload data from the first subset of TFTP data packets, conforming the first payload data to a second protocol, and sending the first payload data to another device prior to receiving a last TFTP data packet for the file, wherein the first payload data is sent in compliance with the second protocol. The method also includes receiving one or more remaining TFTP data packets containing the remaining payload data for the file, the one or more remaining TFTP data packets including the last TFTP data packet for the file, extracting the remaining payload data from the one or more remaining TFTP data packets, and sending the remaining payload data to the other device.

### BACKGROUND

The Trivial File Transfer Protocol (TFTP) is a simple file transfer protocol that is widely used. TFTP can be used to transfer a file to a first TFTP agent from a second TFTP agent. The transfer of the file is initiated by a TFTP request packet (also referred to herein as simply a “request packet”), and can take the form of a read request or a write request. The TFTP agents are often referred to as a TFTP client and TFTP server respectively, where the TFTP client is the agent that sends the TFTP request packet and the TFTP server is the agent that services the TFTP request packet. The details of TFTP are defined in various Internet Engineering Task Force (IETF) Request for Comments (RFC) documents, including RFC 783 (TFTP Protocol (revision 1)), RFC 1350 (TFTP Protocol (revision 2)), RFC 906 (Bootstrap loading using TFTP), RFC 1785 (TFTP Option Negotiation Analysis), RFC 2347 (TFTP Option Extension), RFC 2348 (TFTP Blocksize Option), and RFC 2349 (TFTP Timeout Interval and Transfer Size Options). The TFTP described in such IETF RFC documents is also referred to here as “standard TFTP.”

TFTP requires the TFTP agent that is sending a file to divide the file into a number of equally sized blocks of data, and send each block of data as payload data in a corresponding TFTP data packet (also referred to herein as simply a “data packet”). TFTP also requires that the TFTP agent receiving said file, send an acknowledge packet (also referred to herein as simply an “ACK”) back to the sending TFTP agent for each data packet received. TFTP also requires that the sending TFTP agent, after sending a given packet, wait until an ACK is received from the receiving TFTP agent before sending a subsequent packet. If the sending TFTP agent does not receive an ACK within a 2 second timeout, or receives an ACK with its block number set to the last send block minus 1, the sending TFTP agent re-sends the given packet.

One application of TFTP is in avionic devices. For example, some avionic standards, such as Aeronautical Radio, Incorporated (ARINC) Standard 615A, specify that standard TFTP can be used for loading data from a data loader outside to an aircraft to devices within the aircraft.

### SUMMARY

One embodiment is directed toward a method of transferring data using a Trivial File Transfer Protocol (TFTP). The method includes initiating transfer of a file from a second TFTP agent to a first TFTP agent based on a TFTP request packet and initiating transfer of data from the first TFTP agent to another device according to a second protocol. The method also includes receiving a first subset of TFTP data packets containing first payload data for the file, extracting the first payload data from the first subset of TFTP data packets, conforming the first payload data to the second protocol, and sending the first payload data to the other device prior to receiving a last TFTP data packet for the file, wherein the first payload data is sent in compliance with the second protocol. The method also includes receiving one or more remaining TFTP data packets containing the remaining payload data for the file, the one or more remaining TFTP data packets including the last TFTP data packet for the file, extracting the remaining payload data from the one or more remaining TFTP data packets, and sending the remaining payload data to the other device.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is an example of a prior art system using TFTP to communicate between a data loading device and a target device.

FIG. 2 is a block diagram of an example system for implementing TFTP with data transferring prior to file transfer completion.

FIG. 3 is another block diagram of the system of FIG. 2 showing example components for the devices in the system.

FIG. 4 is a block diagram of another example system for implementing TFTP with data transferring prior to file transfer completion.

FIG. 5 is a block diagram of yet another example system for implementing TFTP with data transfer prior to file transfer completion.

FIG. 6 is a block diagram of still another example system for implementing TFTP with data transfer prior to file transfer completion.

In accordance with common practice, the various described features are not drawn to scale but are drawn to emphasize specific features relevant to the exemplary embodiments.

### DETAILED DESCRIPTION

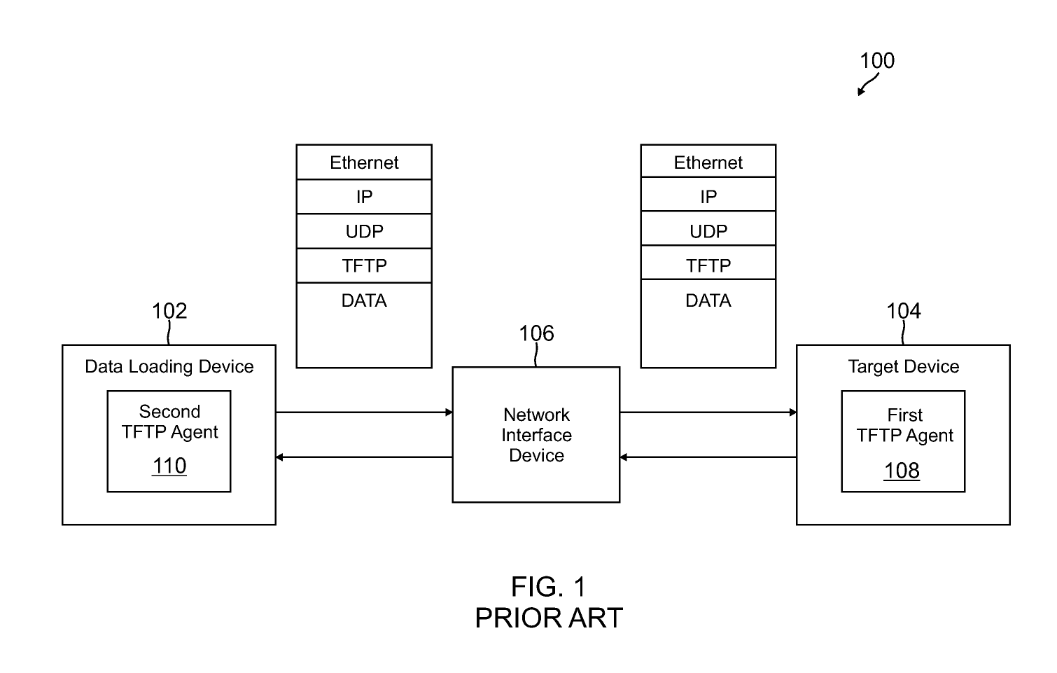

The ACK requirements of TFTP provide high integrity, but can result in slow data transfer since each data packet must be acknowledged before a subsequent data packet can be sent. This sluggish data transfer can be exacerbated when there is a network connection between the first and second TFTP agents involving multiple hops as can be the case when loading data onto avionic devices. FIG. 1 is a block diagram of an example of such a system 100. The system 100 including a data loading device 102 that is communicatively coupled to a target device 104 through a network interface device 106. In system 100 TFTP is used to transfer a file from the data loading device 102 to the target device 104. Accordingly, the target device 104 implements a first TFTP agent 108 and the data loading device 102 implements a second TFTP agent 110.

To transfer a file from the data loading device 102 to the target device 104, a TFTP session is initiated based on a TFTP request packet. In an example, the TFTP session is initiated by the second TFTP agent 110 sending a TFTP write request packet to the first TFTP agent 108. In another example, the TFTP session is initiated by the first TFTP agent 108 sending a TFTP read request packet to the second TFTP agent 110. In either case, once the TFTP session is initiated, the second TFTP agent 110 divides the file up into one or more blocks of data and sends a plurality of data packets containing the data to the first TFTP agent 108 in compliance with TFTP.

The first data packet sent by the second TFTP agent 110 is sent to the network interface device 106. The network interface device 106 forward the first data packet to the first TFTP agent 108 on the target device 104. After receiving the first data packet, the first TFTP agent 108 sends an ACK to the network interface device 106. The network interface device 106 forwards the ACK to the second TFTP agent 110 on the data loading device 102. The second TFTP agent 110 waits until the ACK is received before sending the second data packet. When the ACK is received, the second TFTP agent sends the second data packet. This process is repeated as many times as necessary to send the entire file from the second TFTP agent 110 to the first TFTP agent 108. As shown, in addition to complying with TFTP communications between the data loading device 102, the network interface device 106, and the target device 104 can involve higher level protocols as well such as User Datagram Protocol (UDP), Internet Protocol (IP), and Ethernet protocol.

The TFTP protocol discussed above results in a latency for each data packet equal to an amount of time to traverse from the second TFTP agent 110 to the network interface device 106, to the first TFTP agent 108, and back again. This can be a significant amount when sending a large file with many data packets. Moreover, the amount of time required to send a file using the above protocol can be further exacerbated by slow network links and/or systems with more than one network hop.

The embodiments described herein provide for a system and method that enables TFTP compliance for the data transfer from a data loading device and reduces the overall time required to transfer the file. In particular, the embodiments provide for a system and method where a first TFTP agent is implemented in an intermediary device in the multi-hop communication path between a data loading device and a target device. The first TFTP agent on the intermediary device can satisfy TFTP with a second TFTP agent on the data loading device. The first TFTP agent can also transfer payload data from the data packets received from the second TFTP agent to the target device prior to receiving all the data packets for the file being transferred. That is, the first TFTP agent does not wait until receiving the entire file before sending data from the file to the target device 104. Instead, the first TFTP agent sends portions of the file in a piecemeal fashion to the target device 104 as the portions are received at the first TFTP agent. Thus, transferring of the file from the first TFTP agent to the target device can commence before the file is completely received at the intermediary device. Moreover, since the first TFTP agent is on the intermediary device, data packets sent by the second TFTP agent only need to wait for acknowledgment from the intermediary device and not the target device. Some embodiments also enable the data received at the intermediary device to be sent to multiple target devices in parallel, resulting in reduced time as compared to performing the process described with reference to FIG. 1 individually with multiple target devices

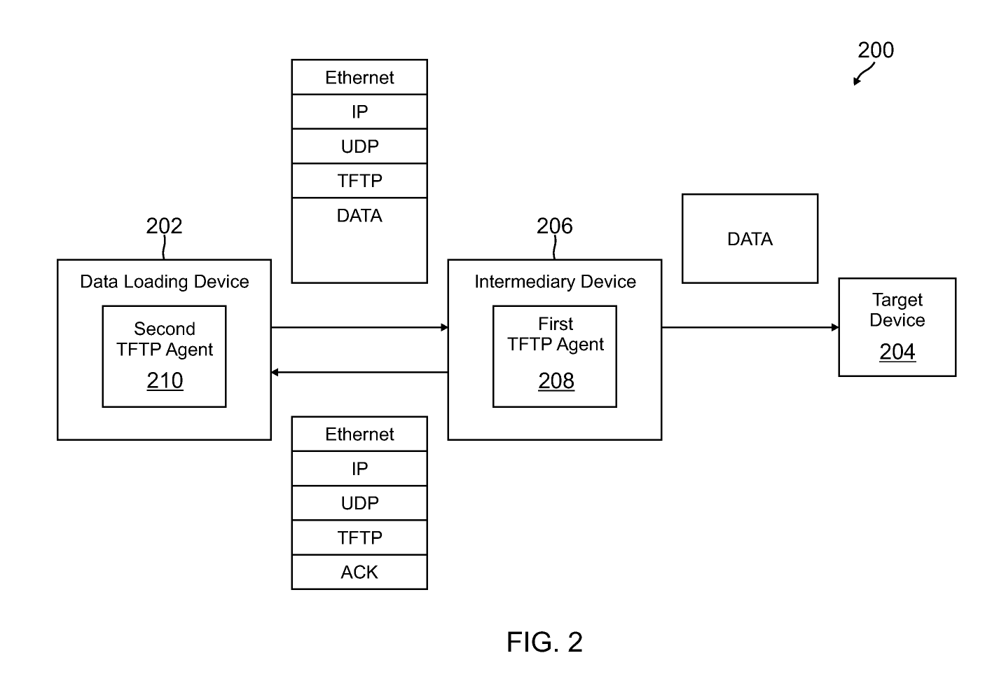

FIG. 2 is a block diagram of an example system 200 for implementing TFTP with data transferring prior to file transfer completion. System 200 includes a data loading device 202, a target device 204, and an intermediary device 206.

The data loading device 202 includes one or more files to be transferred to the target device 204. As describe herein a “file” can include data of any type (such as a complete or partial application layer file, an image of a disc, or other data) where a single “file” corresponds to all the data to be sent over a given TFTP transfer session. In an example, the data loading device 202 is an avionic data-loader configured to be coupled to devices on an aircraft and configured to communicate with devices on the aircraft using ARINC Standard 615A. The target device 204 is an avionic device on an aircraft. Communications between the data loading device 202 and the target device 204 occur via an intermediary device 206. The example shown in FIG. 2 illustrates a single intermediary device 206; however, in other examples multiple intermediary devices can be coupled in series such that communications between the data loading device 202 and the target device 204 hop through each of the multiple intermediary devices. In any case, an intermediary device can be configured to communicatively couple (e.g., via a wired connection) to the data loading device 202. In the example shown in FIG. 2, the intermediary device 206 acts as a network interface for interfacing with the data loader 202 and, in some implementations, with other devices.

As mentioned above, one or more files on the data loading device 202 can be transferred to the target device 204. In compliance with ARINC 615A, the data loading device 202 is configured to implement TFTP for transfer of the file(s). To implement a file transfer using TFTP the intermediary device 206 implements a first TFTP agent 208 and the data loading device 202 implements a second TFTP agent 210. To transfer the file from the second (sending) TFTP agent 210 to the first (receiving) TFTP agent 208, a TFTP session is initiated based on a TFTP request packet. In an example, the TFTP session is initiated by the second TFTP agent 210 sending a TFTP write request packet to the first TFTP agent 208. In another example, the TFTP session is initiated by the first TFTP agent 208 sending a TFTP read request packet to the second TFTP agent 210. In either case, once the TFTP session is initiated, the second TFTP agent 210 divides the file up into one or more blocks of data and sends a plurality of data packets containing the data to the first TFTP agent 208 in compliance with TFTP.

The first data packet is sent from the second TFTP agent 210 to the first TFTP agent 208 on the intermediary device 206. After receiving the first data packet, the first TFTP agent 208 sends an ACK to the second TFTP agent 210. Upon receiving the ACK at the second TFTP agent 210, the second TFTP agent 210 sends the second data packets to the first TFTP agent 208. If a data packet is not received successfully at the first TFTP agent 208 (e.g., is corrupted), the first TFTP agent 208 can send an ACK to the second TFTP agent 210 where the ACK has its block number set to the last (successfully) received data packet. Upon receiving such an ACK, the second TFTP agent 210 re-sends the data packet that was sent prior to the ACK. This process continues in compliance with TFTP until all blocks of data for the file have been sent. After all the blocks of data for the file have been sent, the second TFTP agent 210 sends a last data packet for the file. The last data packet is defined by TFTP to indicate that all the blocks of data for the file have been transferred. The last data packet contains zeroes as payload data which identifies the data packet as a last data packet. After receiving the last data packet, the first TFTP agent 208 sends an ACK to the second TFTP agent 210 and ends the TFTP session for transferring the file. Upon receiving the ACK, the second TFTP agent 210 also ends the TFTP session for transferring the file. In this way, the file is transferred from the second TFTP agent 210 to the first TFTP agent 208 in compliance with TFTP.

While the TFTP session for transferring the file is active and before the last data packet for the file is received, the first TFTP agent 208 transfers data for the file from the data packets that have been received to the target device 204. As used herein the “last data packet for the file” is a last data packet as defined by TFTP that is sent for the TFTP session to transfer the file. Thus, the first TFTP agent 208 sends data for the file obtained from data packets received during the TFTP session to the target device 204, before receiving all the data for the file and, therefore, before receiving all the data packets for the TFTP session. This transfer of data can occur on a regular basis as subsets of data from the file are received. For example, the first TFTP agent 208 can be configured to, after receiving a subset of data packets from the second TFTP agent 210, extract the payload data from the subset of data packets, conform the payload data to a second protocol for sending to the target device 204, and send the conformed payload data to the target device 204. The first TFTP agent 208 can then repeat these acts on the next subset of data packets received. This process can continue until all the payload data from all the data packets for the file has been sent to the target device 204.

In example, each subset of data packets can include the same number of data packets. In one example, each subset of data packets includes a single data packet. In another example, each subset of data packets includes 10 data packets. Regardless of the number of data packets in a subset, the first TFTP agent 208 can be configured to act on the data packets as a subset in order to send data to the target device 208. In some examples, receiving a completed subset of data packets (e.g., a number of packets that completes the subset) is the trigger in which the first TFTP agent 208 is configured to react to perform the above acts of extracting, conforming, and sending. Thus, the first TFTP agent 208 can receive data packets in compliance with TFTP from the second TFTP agent 210. Upon receiving a completed subset of data packets (e.g., before receiving the next subset of data packets), the first TFTP agent 208 can perform the above acts of extracting, conforming, and sending, and this can be repeated for each completed subset of data packets received. Accordingly, the data for the file can be sent to the target device 204 in a piecemeal fashion as it is received at the first TFTP agent 208. In some examples, the number of data packets in different subsets can differ. In any case, the first TFTP agent 208 is configured to act on data packets for a file before receiving the last data packet for the file to send the payload data from the data packets to the target device 204.

Extracting the protocol data can include removing the payload data from its packet by stripping off all the protocol overhead from TFTP and higher layers such as from UDP, IP, and Ethernet to obtain raw data for the file. As mentioned above, this data can then be conformed to a second protocol for sending to the target device 204. Conforming the data to the second protocol can include re-packaging the data in compliance with the second protocol. The second protocol can be any suitable communication protocol, including TFTP. According, in one example, the data obtained from the data packets is re-packaged and sent to the target device 204 in compliance with TFTP in a different TFTP session from the TFTP session used for transfer of the file from the second TFTP agent 210 to the first TFTP agent 208. In another example, the second protocol can be a simple protocol where limited overhead information is sent to the target device 204 in order to reduce the time required to send the data.

After the first TFTP agent 208 receives the last data packet for the file and ends the TFTP session, the first TFTP agent 208 can perform the above process of extracting, conforming, and sending on the remaining data packets for which this process has not been completed. In this way, the data for the file can be transferred from the first TFTP agent 208 to the target device 204.

In examples including multiple intermediary devices, any of the intermediary devices can be configured with the functionality of the first TFTP agent 208 described herein. In a particular implementation having multiple intermediary devices, the intermediary device that is coupled directly to the data loading device 202 is configured with the functionality of the first TFTP agent 208.

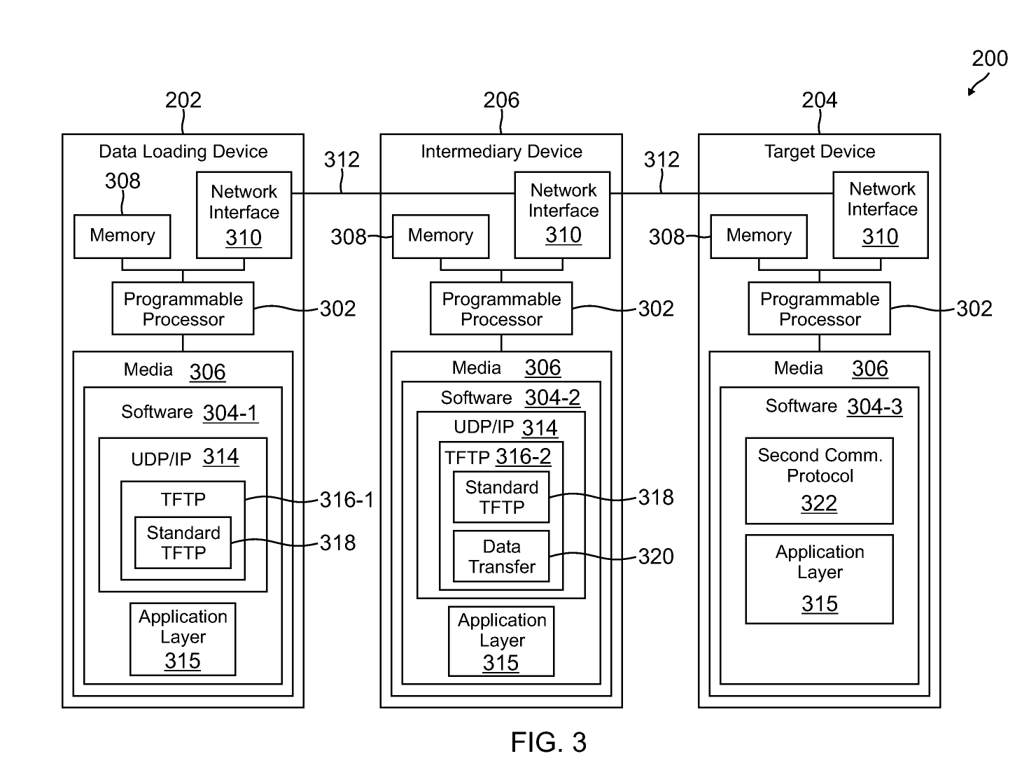

FIG. 3 is another block diagram of the system 200 illustrating example components for the data loading device 202, target device 204, and intermediary device 206. The data loading device 202, target device 204, and intermediary device 206 comprise distinct processing devices. As such, each device 202, 204, 206 includes one or more processing devices 302 for executing instructions 304-1, 304-2, 304-3. The one or more processing devices 302 can include a general purpose processor or special purpose processor. The instructions 304-1, 304-2, 304-3 on each device 202, 204, 206 are stored (or otherwise embodied) on or in an appropriate storage medium or media 306 (such as flash or other non-volatile memory, magnetic disc drives, and/or optical disc drives) from which at least a portion of the program instructions are ready by the programmable processor(s) 302 for execution thereby. Although the storage media 306 is shown in FIG. 3 as being included in, and local to, the respective device 202, 204, 206, it is to be understood that removable media can also be used. Each device 202, 204, 206 also include memory 308 that is coupled to its respective programmable processor(s) 302 for storing instructions (and related data) during execution by the respective programmable processor(s) 302. Memory 308 comprises, in one implementation, any suitable form of random access memory (RAM) now know or later developed, such as dynamic random access memory (DRAM). In other embodiments, other types of memory are used. Each device 202, 204, 206 also includes a network interface 310 for communicatively coupling the device 202, 204, 206 to other devices 202, 204, 206 over a suitable communication medium 312 such as a wire having one or more twisted pairs (e.g., a CATS cable). The communication media 312 between the data loading device 202 and the intermediary device 206 can, but need not, be of the same type as the communication media 312 between the intermediary device 206 and the target device 204.

The instructions 304-1 on the data loader device 202 and the instructions 304-2 on the intermediary device 206 include UDP/IP instructions 314. The UDP/IP instructions 314 implements the UDP/IP suite of protocols and enables application-layer instructions 315 to communicate over the communication medium 312 using the UDP/IP suite of protocols. The UDP/IP instructions 314 also include respective TFTP instructions 316-1, 316-2. The TFTP instructions 316-1 on the data loader device 202 is configured to implement the second TFTP agent 210 as described here and the TFTP instructions 316-2 on the intermediary device 206 is configured to implement the first TFTP agent 208 as describe here. In general, the TFTP instructions 316-1, 316-2 includes standard TFTP functionality 318 that implements standard TFTP as described above with respect to FIG. 1. The TFTP instructions 316-2 on the intermediary device 306 also implements the data transferring prior to file transfer completion functionality 320 described above with respect to FIG. 2 and below with respect to FIGS. 3-5. The data transferring prior to file transfer completion functionality 320 can be implemented, for example, by modifying instructions the implements standard TFTP to further include the functionality 320 describe here.

Although the TFTP instructions 316-1, 316-2 is logically considered to be a part of the UDP/IP instructions 314, at least a part of the TFTP instructions 316-1, 316-2 can be integrated directly into an item of instructions that is otherwise considered to reside outside of the UDP/IP instructions 314 (for example, application layer instructions 315). Also at least a part of the TFTP instructions 316-1, 316-2 can be implemented as a library (or other similar mechanism) that other instructions (for example, application-layer instructions 315) can link to in order to use the TFTP instructions 316-1, 316-2.

The instructions 304-3 on the target device 204 can include second communication protocol instructions 322 that are configured to implement the second communication protocol for transfer of data from the intermediary device 206 to the target device 204. The instructions 304-2 on the intermediary device 206 can also be configured to implement the second communication protocol to transfer data received during a TFTP session from the data loading device 202 to the target device 204.

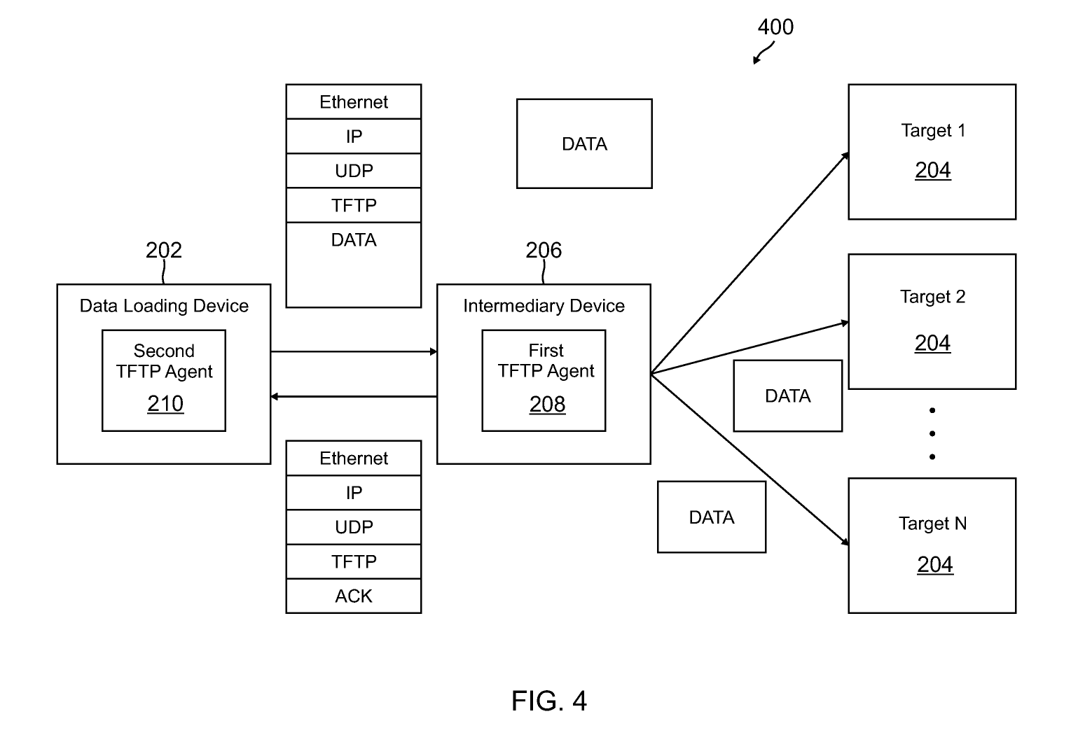

FIG. 4 is a block diagram of another example system 400 in which the TFTP with data transferring prior to file transfer completion can be implemented. System 400 includes the data loading device 202 and the intermediary device 206 as described with respect to system 200. In system 400, however, the intermediary device 206 transfers data to multiple target devices 204. The first TFTP agent 208 on the intermediary device 206 functions as described with respect to FIG. 2 to extract data from data packets received from the second TFTP agent 210 on the data loading device 202. In the example shown in FIG. 4, the first TFTP agent sends the data from the data packets to multiple target devices 204 prior to receiving a last data packet for the file. Thus, each of the multiple target devices 204 can receive data for the file prior to completion of the file transfer to the intermediary device 206. For example, the first TFTP agent 208 can be configured to, after receiving a subset of data packets from the second TFTP agent 210, extract the payload data from the subset of data packets, conform the payload data to one or more second protocols for sending to each target device 204, and send the conformed payload data to each target device 204. The first TFTP agent 208 can then repeat these acts on the next subset of data packets received. This process can continue until all the payload data from all the data packets for the file has been sent to each target device 204.

In an example, each of the target devices 204 communicates with the intermediary device 206 using the same communication protocol. In such an example, the first TFTP agent 208 can conform the extracted data according to said same communication protocol and send a copy of the conformed to each target device 204. In another example, one or more disparate communication protocols can be used for different target devices 204 and the intermediary device 206 creates multiple copies of the extracted data conforms each copy of the extracted data in compliance with a communication protocol used by one or more of the target devices 204 before sending to correspondingly conformed data to each target device 204.

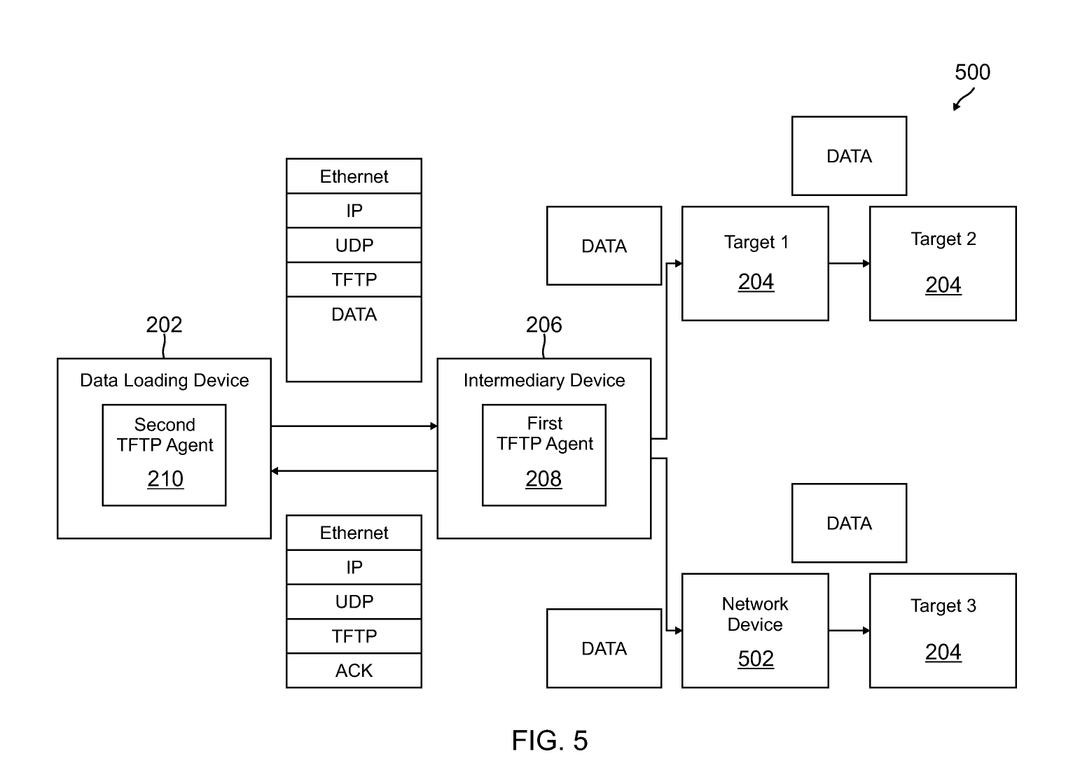

FIG. 5 is a block diagram of another example system 500 in which the TFTP with data transferring prior to file transfer completion can be implemented. System 500 includes the data loading device 202 and the intermediary device 206 described with respect to system 200. As described with respect to FIG. 4, the first TFTP agent 208 can extract payload data from data packets received from the second TFTP agent 210, conform the payload data, and send the payload data to multiple devices. In the example shown in FIG. 5, the multiple devices that receive the data from the first TFTP agent 208 include a first target device 204 and a network device 502 (e.g., a switch, router). The first target device 204 receives the data according to a second communication protocol as described above. In addition, the first target device 204 forwards the data received from the first TFTP agent 208 to a second target device 204. The first target device 204 can forward the data upon the data being received from the first TFTP agent 208 such that the second target device 204 also receives data for the file prior to file transfer completion to the intermediary device 206. The network device 502 comprises another intermediary device and forwards the data received from the first TFTP agent 208 to a third target device 204. The network device 502 can forward the data upon the data being received from the first TFTP agent 208 such that the third target device 204 receives data for the file prior to the file transfer completion to the intermediary device 206.

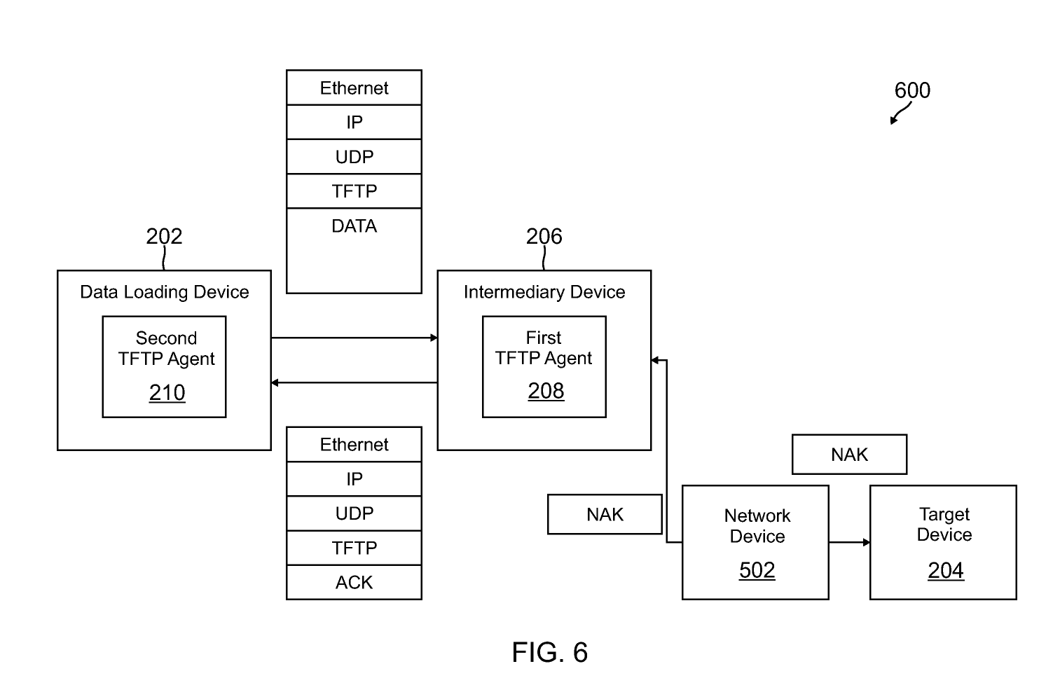

FIG. 6 is a block diagram of another example system 600 in which the TFTP with data transferring prior to file transfer completion can be implemented. System 600 includes the data loading device 202 and the intermediary device 206 described with respect to system 200. As described with respect to FIG. 2, the first TFTP agent 208 can extract payload data from data packets received from the second TFTP agent 210, conform the payload data, and send the payload data to a target device 204. In the example shown in FIG. 6, a second intermediary device, the network device 502 is disposed in the communication path between the intermediary device 206 and the target device 204. The network device 502 can function as described with respect to FIG. 5 to forward data between the intermediary device 206 and the target device 204. In other examples more than one additional intermediary device can be used between the target device 204 and the intermediary device 206.

If the target device 206 does not receive the expected data, the target device 204 can send a NAK back to the first TFTP agent 208 on the intermediary device 206. The network device 502 can obtain the NAK from the target device 204 and forward the NAK to the intermediary device 206. Upon receiving the NAK, the first TFTP agent 208 can take action to re-send the expected data to the target device 204. In an example, the intermediary device 206 temporarily stores some or all of the payload data extracted from the data packets in the media 306 or in the memory 308. To re-send the expected data to the target device, the first TFTP agent 208 can retrieve the expected data from temporary storage in media 306 or memory 308, conform the expected data to the second communication protocol, and send the expected data to the target device 204. In some implementations of such an example, the first TFTP agent 208 can temporarily store all payload data that has been extracted and has not been successfully received at the target device 204. That is, the first TFTP agent 208 can temporarily store all payload data that has been extracted, and continually remove from the temporary storage any payload data that has been successfully received at the target device 204. The first TFTP agent 208 can determine if given payload data has been successfully received based on an ACK received from the target device 204 or the lack of a NAK received at the target device 204 (for example, if no NAK is received at the first TFTP agent 208 within a period of time after sending the data or within a period of time after sending subsequent data). In other implementations, the first TFTP agent 208 can temporarily store all payload data extracted until all the payload data has been successfully received at the target device 204. In another example, instead of temporarily storing the extracted payload data, the first TFTP agent 208 can, after receiving all the data blocks for the file from the second TFTP agent 210 and ending that TFTP session. Initiate another transfer of the file by sending a read-request for the file to the data loading device 202. Upon receiving data blocks for the file, the first TFTP agent 208 can re-send all the payload data or only the portions of the payload data not successfully received by the target device 204. Any of the above methods for re-sending data to the target device 204 can be extended to include multiple target devices 204.

Although specific embodiments have been illustrated and described herein, it will be appreciated by those of ordinary skill in the art that any arrangement, which is calculated to achieve the same purpose, may be substituted for the specific embodiments shown. In particular, although system 200, 400, 500, and 600 have been illustrated as distinct systems, it should be understood that any and all of the features described with respect to systems 400, 500, and 600 can be incorporated into system 200.

What is claimed is:

1. A method of transferring data using a Trivial File Transfer Protocol (TFTP), the method comprising:
initiating transfer of a file from a second TFTP agent to a first TFTP agent based on a TFTP request packet;
initiating transfer of data from the first TFTP agent to another device according to a second protocol;
receiving a first subset of TFTP data packets containing first payload data for the file;
extracting the first payload data from the first subset of TFTP data packets;
conforming the first payload data to the second protocol;
sending the first payload data to the other device prior to receiving a last TFTP data packet for the file, wherein the first payload data is sent in compliance with the second protocol;
receiving one or more remaining TFTP data packets containing the remaining payload data for the file, the one or more remaining TFTP data packets including the last TFTP data packet for the file;
extracting the remaining payload data from the one or more remaining TFTP data packets; and
sending the remaining payload data to the other device.

2. The method of claim 1, wherein sending the first payload data includes sending the first payload data before receiving a second subset of TFTP data packets;
wherein receiving one or more remaining TFTP data packets includes receiving the second subset of TFTP data packets containing second payload data for the file;
wherein extracting the remaining payload data includes extracting the second payload data from the second subset of TFTP data packets; and
wherein sending the remaining payload data includes sending the second payload data prior to receiving a TFTP data packet corresponding to the last TFTP data packet for the file.

3. The method of claim 2, wherein the first subset of TFTP data packets and the second subset of TFTP data packets comprise the same number of TFTP data packets.

4. The method of claim 3, wherein the first subset and second subset comprise a single TFTP data packet.

5. The method of claim 1, wherein payload data from each TFTP data packet containing payload data for the file is extracted and sent to the other device prior to receiving subsequent TFTP data packets containing payload data for the file.

6. The method of claim 1, comprising:
sending the first payload data from the first TFTP agent to a fourth device prior to receiving the last TFTP data packet for the file; and
sending the remaining payload data to the fourth device.

7. The method of claim 1, comprising:
at the first TFTP agent temporarily storing the first payload data;
receiving an indication that from the other device indicating that the other device did not correctly receive a portion of the first payload data; and
resending the portion of the first payload data from first payload data that was temporarily stored.

8. The method of claim 1, comprising:
receiving an indication at the first TFTP agent from the other device indicating that the other device did not correctly receive a portion of the first payload data;
after receiving the last TFTP data packed for the file, sending TFTP request packet to the TFTP server requesting to send the file again;
receiving a second plurality of TFTP data packets corresponding to the file as resent; and
sending at least the portion of the first payload data from the second TFTP agent to the other device.

9. The method of claim 1, wherein the second protocol comprises another session of TFTP or a session of a different protocol.

10. A device implementing a Trivial File Transfer Protocol (TFTP), the device comprising:
one or more processing devices; and
one or more storage devices coupled to the one or more processing devices and including instructions which, when executed by the one or more processing devices, cause the one or more processing devices to execute a first TFTP agent to:
initiate a transfer of a file from a second TFTP agent to the first TFTP agent based on a TFTP request packet;
initiate a transfer of data from the first TFTP agent to another device according to a second protocol;
receive a first subset of TFTP data packets containing first payload data for the file;
extract the first payload data from the first subset of TFTP data packets;
conform the first payload data to the second protocol;
send the first payload data to the other device prior to receiving a last TFTP data packet for the file, wherein the first payload data is sent in compliance with the second protocol;
receive one or more remaining TFTP data packets containing the remaining payload data for the file, the one or more remaining TFTP data packets including the last TFTP data packet for the file;
extract the remaining payload data from the one or more remaining TFTP data packets; and
send the remaining payload data to the other device.

11. The TFTP interface device of claim 10, wherein send the first payload data includes send the first payload data before receiving a second subset of TFTP data packets;
wherein receive one or more remaining TFTP data packets includes receive the second subset of TFTP data packets containing second payload data for the file;
wherein extracting the remaining payload data includes extracting the second payload data from the second subset of TFTP data packets; and
wherein sending the remaining payload data includes sending the second payload data prior to receiving a TFTP data packet corresponding to the last TFTP data packet for the file.

12. The TFTP interface device of claim 11, wherein the first subset of TFTP data packets and the second subset of TFTP data packets comprise the same number of TFTP data packets.

13. The TFTP interface device of claim 12, wherein the first subset and second subset comprise a single TFTP data packet.

14. The TFTP interface device of claim 10, wherein payload data from each TFTP data packet containing payload data for the file is extracted and sent to the other device prior to receiving subsequent TFTP data packets containing payload data for the file.

15. The TFTP interface device of claim 10, wherein the instructions cause the one or more processing devices to execute a first TFTP agent to:
send the first payload data to a fourth device prior to receiving the last TFTP data packet for the file; and
send the remaining payload data to the fourth device.

16. The TFTP interface device of claim 10, wherein the instructions cause the one or more processing devices to execute a first TFTP agent to:
temporarily store the first payload data;
receive a negative acknowledgement from the other device indicating that the other device did not correctly receive a portion of the first payload data; and
resend the portion of the first payload data from first payload data that was temporarily stored.

17. The TFTP interface device of claim 10, wherein the instructions cause the one or more processing devices to execute a first TFTP agent to:
receive an indication from the other device indicating that the other device did not correctly receive a portion of the first payload data;
after receiving the last TFTP data packed for the file, send TFTP request packet to the TFTP server requesting to send the file again;
receive a second plurality of TFTP data packets corresponding to the file as resent; and
send at least the portion of the first payload data to the other device.

18. The TFTP interface device of claim 10, wherein the second protocol comprises another session of TFTP or a session of a different protocol.

19. A method of transferring data using a Trivial File Transfer Protocol (TFTP), the method comprising:
initiating a TFTP session for transfer of a file from a second TFTP agent to a first TFTP agent based on a TFTP request packet;
receiving one or more TFTP data packets at the first TFTP agent; and
at the first TFTP agent, repeating performing the following for each subset of N TFTP data packets received, where N is a number greater than or equal to one:
extracting payload data from the subset of N TFTP data packets;
conforming the payload data to a second protocol for transfer of data corresponding to the file from the first TFTP agent to another device;
sending the first payload data to the other device;
wherein extracting, conforming, and sending occur prior to receiving a subsequent subset of N TFTP data packets.

20. The method of claim 19, wherein after receiving a last TFTP data packet for the file, performing extracting, conforming, and sending to send payload data from a final subset to the other device, the final subset including TFTP data packets from the last full subset of N TFTP data packets up to the last TFTP data packet.
